(19) United States
(12) Patent Application Publication
(10) Pub. No.: US 2009/0150573 A1
(43) Pub. Date: Jun. 11, 2009

(54) INFORMATION PROCESSING APPARATUS AND INFORMATION PROCESSING METHOD

(75) Inventor: Eriko Ozaki, Hachioji-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/329,427

(22) Filed: Dec. 5, 2008

(30) Foreign Application Priority Data
Dec. 7, 2007 (JP) 2007-317335

(51) Int. Cl. G06F 3/00

(52) U.S. Cl. 710/15

(57) ABSTRACT

An information processing apparatus includes a detector configured to detect connection of an external device, a determination unit configured to determine whether content associated with the external device is included in the content data, and an external device operation controller configured to set the content associated with the external device to be content to be operated by the external device when the detector detects the connection of the external device and the determination unit determines that the content associated with the external device is included in the content data.

### BACKGROUND OF THE INVENTION

1. Field of the Invention

The present invention relates to an information processing apparatus and an information processing method. More particularly, the present invention relates to an information processing apparatus and a method for restricting reproduction of content which is not to be reproduced by connecting a device which obtained the content and issuing an instruction even after the content has been moved from the device.

2. Description of the Related Art

In recent years, digital network techniques have been developed, and in general, multimedia data of a peripheral device, such as image pickup data of a digital still camera, is obtained through a network and is reproduced using a PC (Personal Computer), for example. Since capacity of a memory included in the digital still camera and capacity of a hard disk of the PC have been increased, an amount of data which is stored in the memory or the hard disk is also increased, and therefore, it is difficult to recognize all content items of the stored data. Therefore, personal data may be accidentally reproduced when data blocks of various peripheral devices are reproduced for other people. To address this problem, a method for setting attribute representing reproduction prohibition to data in advance or a method for cancelling obtaining of data which should not be reproduced have been proposed.

For example, Japanese Patent Laid-Open No. 2004-32063 discloses a technique of hiding image data which is set to be reproduction-banned data from people other than a user who performs the setting in an attribute changing mode in which reproduction of the image data is banned.

Japanese Patent Laid-Open No. 2003-283901 discloses a technique of, when image data obtained using a digital still camera is to be transmitted through a connection, repeatedly performing transmission of a thumbnail image before transmission of the image data, and interruption of the transmission in response to an instruction representing interruption of image transmission.

Alternatively, a method for performing an operation using a handy device has been proposed. For example, Japanese Patent Laid-Open No. 2005-184208 discloses a technique of switching modes between a mode in which image data can be transmitted and a mode in which transmission of image data is banned in response to an operation performed using a digital still camera being connected.

However, there arises a problem in that, in the technique disclosed in Japanese Patent Laid-Open No. 2004-32063, since image data should be set as reproduction-banned data in advance, when image data which is not to be reproduced is found after the connection, it is difficult to set the image data to be reproduction-banned data. Furthermore, there arises another problem in that image data which has been obtained and which has not already been stored in a digital still camera cannot be set as reproduction-banned data.

In the technique disclosed in Japanese Patent Laid-Open No. 2003-283901, before image data blocks are transmitted, thumbnail images corresponding to the image data blocks should be transmitted in advance, and furthermore, instructions of interruption should be issued for the corresponding image data blocks. Therefore, a method for transmitting image data blocks and timing in which instructions of interruption are transmitted are restricted.

In the technique of Japanese Patent Laid-Open No. 2005-184208, merely determination as to whether image data is transmitted by operating a digital still camera is made as a setting operation. Therefore, there arises a problem in that even when the image data was obtained using the digital still camera, if the image data has already been moved from the digital still camera, an operation performed on the image data cannot be restricted.

### SUMMARY OF THE INVENTION

The present invention provides a method for easily restricting reproduction of content which is not to be reproduced by connecting a device which obtained the content and issuing an instruction even after the content has been moved from the device.

According to an exemplary embodiment of the present invention, there is provided an information processing apparatus including a detector configured to detect connection of an external device, a determination unit configured to determine whether content associated with the external device is included in the content data, and an external device operation controller configured to set the content associated with the external device to be content to be operated by the external device when the detector detects the connection of the external device and the determination unit determines that the content associated with the external device is included in the content data.

According to another exemplary embodiment of the present invention, there is provided an information processing method for an information processing apparatus. The information processing method includes detecting connection of an external device, determining whether content associated with the external device is included in content data, and setting the content associated with the external device to be content to be operated by the external device when the connection of the external device is detected and it is determined that the content associated with the external device is included in the content data.

Accordingly, when an operation to be performed on a certain content item is to be restricted, and when the certain content item has already been moved from a device which obtained the certain content item, the operation to be performed on the certain content item can be easily restricted by connecting the device and issuing an instruction from the device.

Further features of the present invention will become apparent from the following description of exemplary embodiments (with reference to the attached drawings).

### BRIEF DESCRIPTION OF THE DRAWINGS

FIG. 1 illustrates a first example of a hardware configuration of a content management apparatus according to a first exemplary embodiment of the present invention.

FIG. 2 illustrates a first example of a functional configuration of the content management apparatus according to the first exemplary embodiment.

FIG. 3 is a flowchart illustrating an example of processing of controlling content obtained by an external device performed using the external device when connection of the external device is detected.

FIG. 4 illustrates a second example of the hardware configuration of the content management apparatus according to the first exemplary embodiment.

FIG. 5 illustrates a second example of the functional configuration of the content management apparatus according to the first exemplary embodiment.

FIG. 6 illustrates an example of a hardware configuration of a content management apparatus according to a second exemplary embodiment.

FIG. 7 illustrates an example of a functional configuration of the content management apparatus according to the second exemplary embodiment.

FIG. 8 illustrates a first example of a display screen.

FIG. 9 illustrates a second example of the display screen.

FIG. 10 is a flowchart illustrating an example of processing of hiding content obtained by an external device so that the content is not displayed when an operation command is transmitted from the external device which is connected.

FIG. 11 illustrates an example of a functional configuration of a content management apparatus according to a third exemplary embodiment.

FIG. 12 is a flowchart illustrating an example of an operation of deleting content obtained from an external device when a predetermined time period is elapsed after an operation command is transmitted from the external device which is connected.

### DESCRIPTION OF THE EXEMPLARY EMBODIMENTS

Exemplary embodiments of the present invention will be described hereinafter with reference to the accompanying drawings.

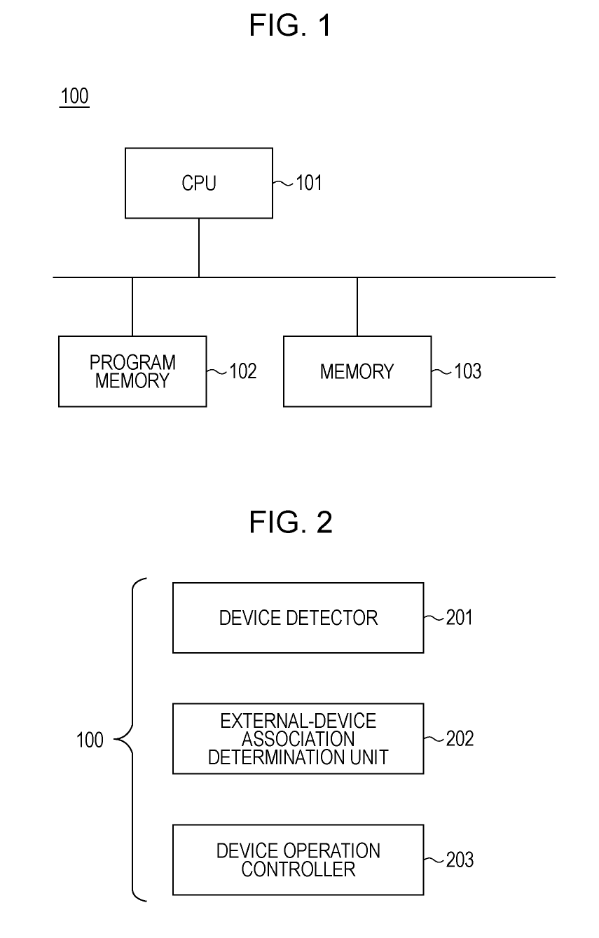

FIG. 1 illustrates a first example of a hardware configuration of a content management apparatus according to a first exemplary embodiment. The content management apparatus corresponds to an information processing apparatus (computer), for example.

As shown in FIG. 1, a content management apparatus 100 includes a CPU 101, a program memory 102, and a memory 103 as the hardware configuration. Note that, although not shown, the content management apparatus 100 includes a plurality of interfaces used to connect the content management apparatus 100 to other devices. Hardware configurations described below are similar to this configuration.

The CPU 101 performs various calculations and logical determinations and controls various components connected to a bus. The program memory 102 stores programs which are executed using the CPU 101 so as to execute operations of a flowchart and functions described below. The memory 103, corresponding to a content storage device, for example, stores data (for example, content, which will be described hereinafter) used to execute the programs using the CPU 101.

When the CPU 101 executes the programs stored in the program memory 102, all or part of the operation in the flowchart and the functions, which will be described below, is realized.

FIG. 2 is a diagram illustrating a first example of a functional configuration of the content management apparatus according to the first exemplary embodiment.

Referring to FIG. 2, the content management apparatus 100 includes a device detector 201, an external-device association determination unit 202, and a device operation controller 203 as a functional configuration. The device detector 201 detects a connection between an external device and the content management apparatus 100. Furthermore, the device detector 201 obtains information on the external device from the external device connected to the content management apparatus 100.

The external-device association determination unit 202 determines an external device which transmitted content to the content management apparatus 100 which has been managing the content or determines an external device which generated content which has been managed using the content management apparatus 100. That is, the external-device association determination unit 202 determines an external device relating to (associated with) content which has been managed using the content management apparatus 100.

The device operation controller (external device operation controller) 203 controls operation of the content management apparatus 100 performed on content which has been managed using the content management apparatus 100 in accordance with an operation of an external device. The device operation controller 203 allows the operation performed using the external device only while connection between the content management apparatus 100 and the external device is recognized by the device detector 201.

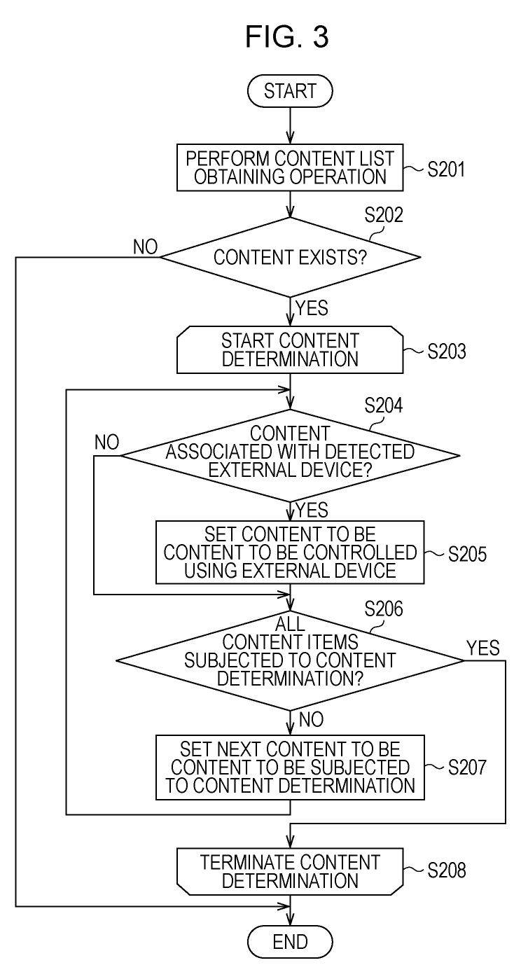

FIG. 3 is a flowchart illustrating an example of processing of allowing an external device to control content associated with the external device when connection between the content management apparatus 100 and the external device is detected.

When the device detector 201 detects connection between the content management apparatus 100 and an external device, the device detector 201 performs the following operation. In step S201, the external-device association determination unit 202 obtains (or generates) a content list listing content items stored in the memory 103 included in the content management apparatus 100 and content items stored in the external device connected to the content management apparatus 100. The content list is an example of content data.

In step S202, the external-device association determination unit 202 determines whether information on content (content information) is included in the content list obtained in step S201 (that is, the external-device association determination unit 202 determines whether content exists). When the determination is negative (that is, when the content does not exist), the external-device association determination unit 202 terminates the operation of FIG. 3. On the other hand, when the determination is affirmative (that is, when the content exists), the external-device association determination unit 202 proceeds to step S203.

In step S203, the external-device association determination unit 202 starts performing a determination operation as to whether content items corresponding to content information items included in the content list are associated with the detected external device which is connected to the content management apparatus 100.

In step S204, the external-device association determination unit 202 determines whether a content item corresponding to a first content information item among the content information items included in the content list is associated with the detected external device. When the content item is included in the external device, when the content item was generated in the external device, or when the content item was obtained from the external device, it is determined that the content item is associated with the external device.

The external-device association determination unit 202 determines whether the content item is associated with the external device on the basis of the content information including information on location where the content item exists, information on location where the content item is generated, and information on an obtaining source, and device information (external device information) obtained using the device detector 201. When the determination is affirmative in step S204 (that is, the content item is associated with the external device), the process proceeds to step S205. On the other hand, when the determination is negative in step S204 (that is the content item is not associated with the external device), the process proceeds to step S206.

In step S205, the device operation controller 203 sets the content item subjected to the processing to a content item to be controlled (content to be operated) by the detected external device which is connected to the content management apparatus 100. Specifically, the device operation controller 203 adds, to the content item subjected to the processing, information representing that the content item subjected to the processing corresponds to a content item controlled by the external device which is connected to the content management apparatus 100.

In step S206, the external-device association determination unit 202 determines whether all content items corresponding to the content information items included in the content list have been subjected to the determination operation.

When the determination is affirmative in step S206 (that is, all content items have been subjected to the determination operation), the process proceeds to step S208. On the other hand, when the determination is negative in step S206 (that is, not all content items have been subjected to the determination operation), the process proceeds to step S207.

In step S207, the external-device association determination unit 202 sets the next content item corresponding to the next content information item included in the content list as a content item to be subjected to the processing, and the process returns to step S204. Thereafter, the determination operation is repeatedly performed on all the content items corresponding to the content information items included in the content list until the external-device association determination unit 202 determines that all the content items have been subjected to the determination operation in step S206. When it is determined in step S206 that all content items have been subjected to the content determination, processing advances to step S208 and the processing illustrated in FIG. 3 and described above ends.

By performing the processing described above, the content items obtained from the digital still camera are stored in the content management apparatus 100. However, when a user wishes to view the content items which are managed in the content management apparatus 100 and one of the content items is not to be reproduced, the digital still camera which obtained the content item which is not to be reproduced is connected to the content management apparatus 100. Then, data blocks obtained using the digital still camera are recognized as content items which can be operated by the digital still camera. By this, the content item not to be reproduced can be excluded from content items to be displayed in response to an operation of the content management apparatus 100, for example.

According to this exemplary embodiment, the content management apparatus 100 obtains the content list including the information items (content information items) corresponding to all the content items, and determines whether each of the content items is associated with the external device. However, the content management apparatus 100 may eliminate content items stored in the detected external device which is connected to the content management apparatus 100 from the content list.

In step S205, the device operation controller 203 adds, to the content item subjected to the processing, information representing that the content item subjected to the processing corresponds to a content item controlled by the external device which is connected to the content management apparatus 100. However, the device operation controller 203 may associate identification information used to identify the content item subjected to the processing with information representing a content item controlled by the external device which is connected to the content management apparatus 100 so as to store the identification information and the information representing a content item controlled by the external device in a table, for example, in the memory 103.

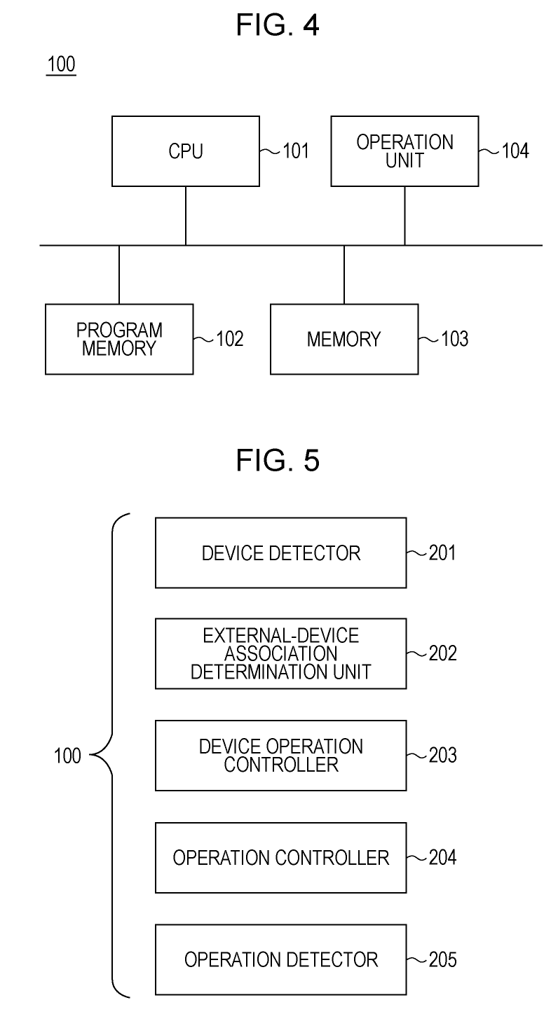

Another example of the hardware configuration of the content management apparatus 100 in which the content management apparatus 100 additionally includes an operation unit 104 is described below. FIG. 4 illustrates a second example of the hardware configuration of the content management apparatus 100 according to the first exemplary embodiment.

The operation unit 104 accepts a user's operation and inputs operation information to the content management apparatus 100 in response to the user's operation.

Another example of the functional configuration of the content management apparatus 100 having such a hardware configuration is shown in FIG. 5. FIG. 5 illustrates a second example of the functional configuration of the content management apparatus according to the first exemplary embodiment.

As shown in FIG. 5, the operation unit 104 additionally includes an operation controller 204 and an operation detector 205 as the functional configuration. The operation detector 205 detects an operation of the operation unit 104 performed by the user. Furthermore, the operation detector 205 receives operation information (an operation command) in accordance with the detected operation and supplies the operation information to the operation controller 204.

In response to the received operation information, the operation controller 204 performs an operation on a content item of interest. When the content item of interest is associated with the detected external device, the operation controller 204 performs a control operation so that an operation performed using the external device prioritized over an operation performed using the operation unit 104. That is, the operation controller 204 performs the control operation so that the operation performed using the external device matches an operation detected using the operation detector 205 (the operation performed using the operation unit 104). That is, when the content item of interest is associated with the detected external device, the operation controller 204 gives a priority to the operation detected using the operation detector 205 (the operation performed using the operation unit 104).

With this configuration, before another person operates a content item of interest obtained from the external device using the content management apparatus 100, the external device is connected to the content management apparatus 100 so that the content item of interest is controlled (preferentially operated) using the external device.

The device operation controller 203 may detect cancellation of connection of the external device (that is, a change of a connection state) as an operation of the external device and operate (or control) the content item which was to be operated using the external device in accordance with the operation.

Furthermore, the device operation controller 203 may detect an on-state or an off-state of the external device (that is, a change of a power-supply state) as an operation of the external device and operate (or control) the content item which was to be operated using the external device in accordance with the operation.

Moreover, the device operation controller 203 may detect inclination of the external device (that is, a change of an inclination state) as an operation of the external device and operate (or control) the content item which was to be operated using the external device in accordance with the operation.

Note that among the operations of the external device, an operation used to operate the content item of interest using the external device may be set to the content management apparatus 100 in advance or may be set by the user.

As described above, according to this exemplary embodiment, in a case where a content item is to be controlled so as not to be reproduced, for example, the user should perform an operation after the device which supplied the content is connected to the content management apparatus 100. By this, an operation performed on a content item which has already moved from the device is easily controlled. Furthermore, a priority is given to an operation performed using the device on a content item associated with the device connected to the content management apparatus 100. Accordingly, when the user merely operates the device in hand while the device is connected to the content management apparatus 100, the content associated with the device is prevented from being operated using the content management apparatus 100 or another device connected to the content management apparatus 100.

As a second exemplary embodiment, a case where a content management apparatus 100 changes display modes used to display a content item associated with an external device under control of the external device which is connected to the content management apparatus 100 will be described.

In this case, the user can easily change content-display modes as desired, and accordingly, convenience is improved.

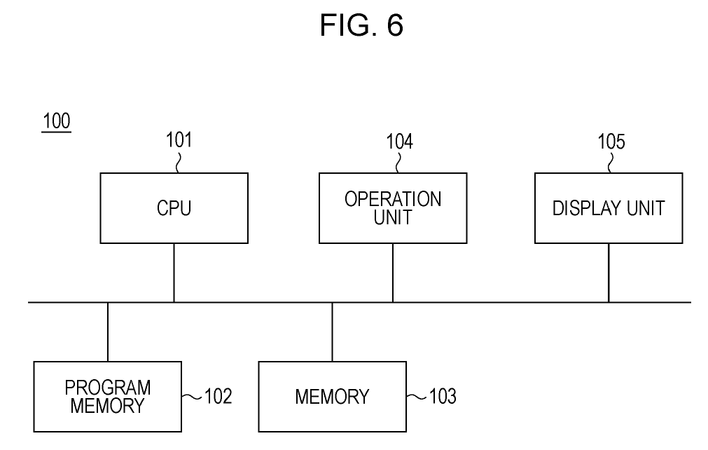

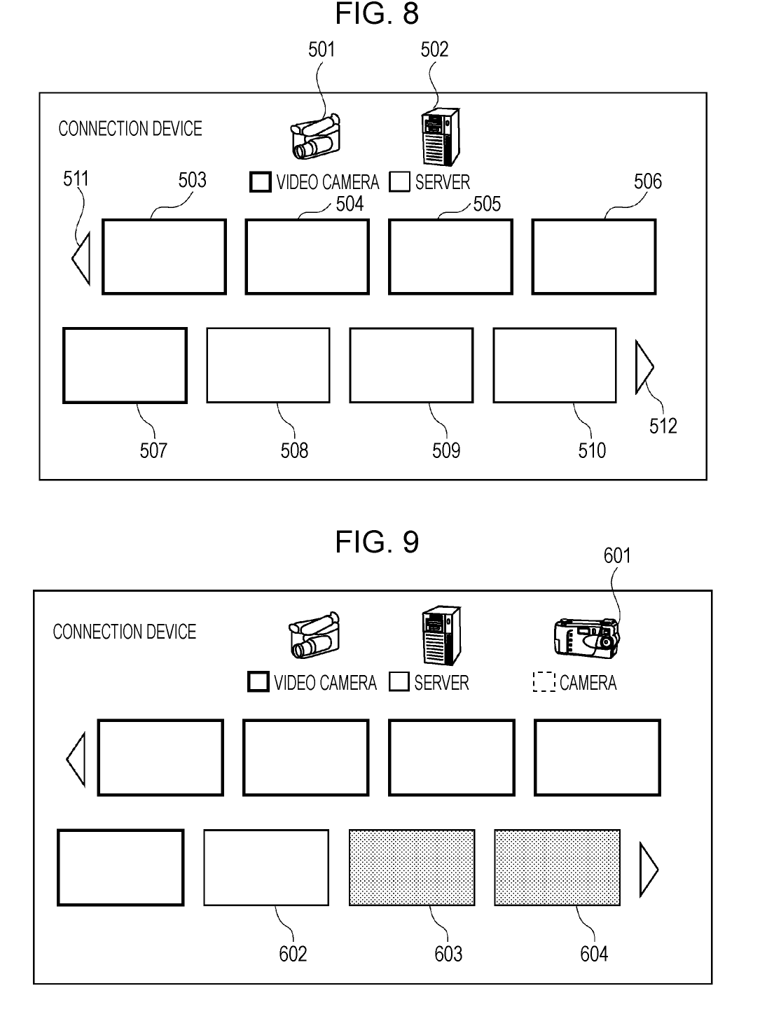

FIG. 6 illustrates an example of a hardware configuration of the content management apparatus 100 according to the second exemplary embodiment. As shown in FIG. 6, the content management apparatus 100 of the second exemplary embodiment includes a display unit 105 in addition to the components of the hardware configuration shown in FIG. 4. The display unit 105 displays display screens shown in FIGS. 8 and 9, which will be described hereinafter.

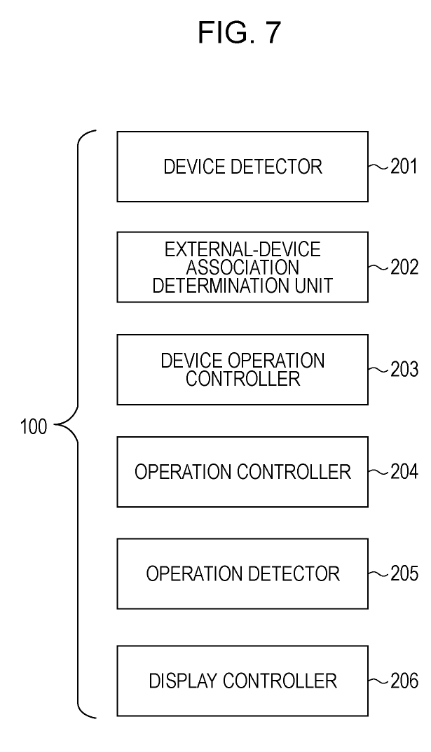

FIG. 7 illustrates an example of a functional configuration of the content management apparatus 100 according to the second exemplary embodiment.

As shown in FIG. 7, the content management apparatus 100 of the second exemplary embodiment includes a display controller 206 in addition to the components of the functional configuration shown in FIG. 5. The display controller 206 controls display of content items in the display screens displayed in the display unit 105.

FIG. 8 illustrates a first example of the display screens. The display screen includes an icon representing a video camera 501 and an icon representing a server 502. The video camera icon 501 and the server icon 502 are displayed on the display screen so as to represent the video camera and the server, respectively, as external devices in which connections to the content management apparatus 100 are detected by the content management apparatus 100. The term “icon” corresponds to a small picture or a small sign representing a detailed processing operation or an object to be subjected to the processing operation. Furthermore, thumbnails 503 to 510 represent content items stored in the content management apparatus 100 and the external devices which are determined to be connected to the content management apparatus 100, or the content items described above. In this exemplary embodiment, the thumbnails 503 to 507 (which are outlined in bold like the box below the video camera icon 501) represent content items stored in the video camera, and the thumbnails 508 to 510 (which are outline with a normal solid line) represent content items stored in the server.

If the content items are not displayed in a single screen at a time, the display controller 206 displays content items before the content item 503 in the display screen in accordance with a press of a left button 511 which is displayed in the screen. Similarly, the display controller 206 displays content items after the content item 510 in the display screen in accordance with a press of a right button 512 which is displayed in the screen. In addition to the objects shown in FIG. 8, in the display screen, buttons used for controlling the content items such as buttons used for execution of searching for a certain content item, search refinement, printing, reproducing, and deleting may be displayed. In addition to the display control and the operation control performed using the buttons displayed in the display screen, the operation detector 205 may detect an operation of a remote controller, for example, and in accordance with a result of the detection, the display controller 206 may perform display control and the operation controller 204 and the device operation controller 203 may perform operation control on the content items.

FIG. 9 illustrates a second example of the display screens. The display screen shown in FIG. 9 shows an example of display in which content items associated with an external device are controlled in accordance with an operation of the external device connected to the content management apparatus 100.

An icon 601 represents a digital still camera which is an external device newly connected to the content management apparatus 100. Thumbnails of content items stored in the digital still camera would be outlined in a dashed line like the box shown below the digital still camera icon 601. In the exemplary embodiment shown in FIG. 9, no thumbnails for images stored in the digital still camera are shown. As described below, although some of the content items may have originally come from the digital still camera, if they are stored on the server, the thumbnails indicate that the content items are stored on the server. Thumbnails 602 to 604 (outlined with a normal line) represent content items stored in the server connected to the content management apparatus 100. Among the thumbnails 602 to 604, the thumbnails 603 and 604 represent content items associated with the digital still camera which is the newly connected external device. The display controller 206 controls the thumbnails 603 and 604 so that the thumbnails 603 and 604 corresponding to the content items are displayed so that detailed information items corresponding to the content items are not recognized while display frames for the thumbnails 603 and 604 remain. That is, the display controller 206 performs display control so that the thumbnails representing the content items are displayed so as to represent that operations performed on the content items associated with the digital still camera which is the newly connected external device using the operation unit 104 are not accepted.

The display controller 206 may perform display control so that the thumbnails 603 and 604 corresponding to the content items associated with the digital still camera are shown as grayout display and detailed information on the content items which are represented by the thumbnails 603 and 604 and which are associated with the digital still camera serving as the newly connected external device are not recognized as shown in FIG. 9 in accordance with an operation. Alternatively, the display controller 206 may perform display control so that the thumbnails 603 and 604 are not displayed. Note that the display controller 206 performs the display control so that, when the thumbnails corresponding to the content items are not to be displayed, regions in which the thumbnails 603 and 604 are located are occupied by other thumbnails corresponding to other content items. Note that any display method may be employed unless the detailed information of the content items corresponding to the thumbnails 603 and 604 is not recognized, and this exemplary embodiment is not limited to the display methods described above.

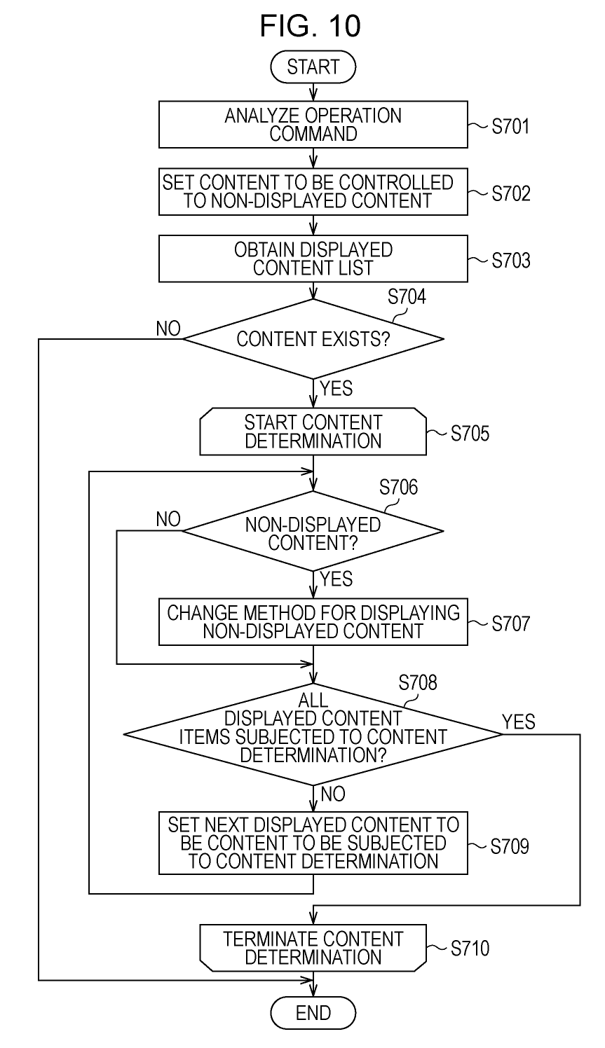

FIG. 10 is a flowchart illustrating an example of processing of hiding content items associated with an external device so that the content items are not displayed when an operation command is transmitted from the connected external device. When the operation detector 205 detects operation information (an operation command) transmitted from the external device, the device operation controller 203 analyzes the operation command and identifies the external device which transmitted the operation command in step S701.

In step S702, the device operation controller 203 or the display controller 206 sets a content item which was selected as a content item to be operated when the external device is connected to the content management apparatus 100 to be a non-displayed content item.

In step S703, a content list listing content items which are being displayed in the display screen is obtained (or generated).

In step S704, the display controller 206 determines whether content information is included in the content list obtained in step S703 (that is, the display controller 206 determines whether a content item exists). When the determination is negative in step S704 (that is, when the content item does not exist), the display controller 206 terminates the processing of FIG. 10. On the other hand, when the determination is affirmative (that is, when the content item exists), the display controller 206 proceeds to step S705.

In step S705, the display controller 206 starts performing a determination as to whether content items corresponding to content information items included in the content list are the non-displayed content items.

In step S706, the display controller 206 determines whether a content item corresponding to a first content information item included in the content list is the non-displayed content item set in step S702. When the determination is affirmative in step S706, the process proceeds to step S707. On the other hand, when the determination is negative in step S706, the process proceeds to step S708.

In step S707, the display controller 206 changes a display state of the content item to be subjected to the processing to a non-display state.

In step S708, the display controller 206 determines whether all the content items corresponding to the content information items included in the content list have been subjected to the determination operation. When the determination is affirmative in step S708, the display controller 206 proceeds to step S710. On the other hand, when the determination is negative in step S708, the display controller 206 proceeds to step S709.

In step S709, the display controller 206 sets the next content item corresponding to the next content information item included in the content list as a content item to be processed, and the process returns to step S706. Thereafter, the determination operation is repeatedly performed on all the content items corresponding to the content information items included in the content list until the display controller 206 determines that all the content items have been subjected to the determination operation in step S708. When it is determined in step S708 that all the content items have been subjected to the determination operation, processing proceeds to step S710 and the processing shown in FIG. 10 ends.

In this embodiment, the display controller 206 performs the display control so that non-displayed content items are prevented from being displayed in the screen every time content items displayed in the display screen are changed due to changes of display states.

Although the content management apparatus 100 does not allow the content items associated with the external device to be displayed in the screen by detecting an operation of the external device, a method for the display control may be changed in accordance with an operation. For example, in the content management apparatus 100, a content item which was set as a non-displayed content item in accordance with an operation may be displayed again by changing a non-display mode to a display mode, for example, in accordance with a predetermined operation. Furthermore, the content management apparatus 100 may perform a control operation (restriction operation) so that although the non-displayed content items are displayed in the content list, a reproducing operation, a copying operation, or a printing operation, for example, are not performed on the non-displayed content items.

Furthermore, any operation may correspond to the operation of the external device as long as the content management apparatus 100 detects the operation of the external device, and different operations may be performed in different external devices as operations of the external devices. Moreover, the content management apparatus 100 may change a control operation in accordance with the operation of the external device. In this case, the content management apparatus 100 may be configured so that operations of the content management apparatus 100 are set by the user, that is, the content management apparatus 100 may be configured so that certain control operations performed in response to certain corresponding operations are set in the memory 103 in advance.

As described above, according to this exemplary embodiment, when an operation to be performed on a content item is to be restricted, a device which obtained the content item is connected to the content management apparatus 100 and operated. Accordingly, even when the content item has already been moved from the device, the operation to be performed on the content item is easily restricted.

As a third exemplary embodiment, a case where a content management apparatus 100 deletes content items associated with an external device which is managed by the content management apparatus 100 in accordance with elapsed control time when a control signal of the external device which is determined to be connected to the content management apparatus 100 is detected, will be described.

In this case, content items which are unnecessarily scattered are automatically deleted while a user is not aware of the deletion, and accordingly, convenience is improved.

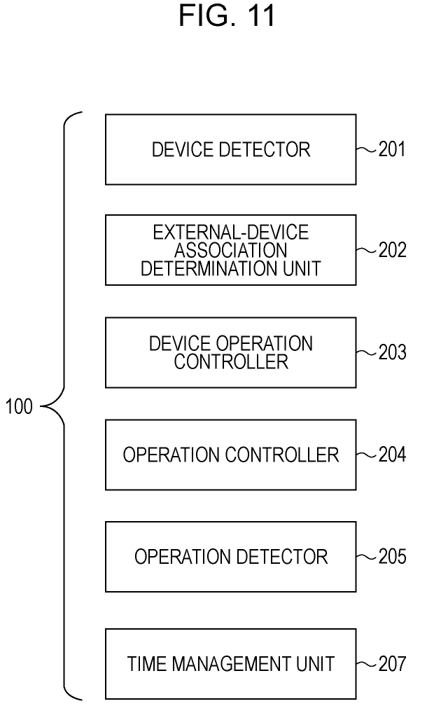

FIG. 11 illustrates an example of a functional configuration of the content management apparatus 100 according to the third exemplary embodiment. A hardware configuration of the content management apparatus 100 of the third exemplary embodiment is the same as the hardware configuration of the content management apparatus 100 of the first exemplary embodiment shown in FIG. 4.

As shown in FIG. 11, the content management apparatus 100 of the third exemplary embodiment includes a time management unit 207 in addition to the components of the functional configuration shown in FIG. 5. The time management unit 207 detects an operation of the connected external device and measures and manages a time period in which a content item is controlled. Note that although the time management unit 207 is configured as software (functional configuration) in this exemplary embodiment, the time management unit 207 may be implemented in the content management apparatus 100 as hardware. Similarly, among the components, components which are described as software may be implemented in the content management apparatus 100 as hardware.

The content management apparatus 100 stores content items in a memory 103 by obtaining the content items from the external device physically connected to the content management apparatus 100 or a memory of the external device or by downloading the content items through a network. In addition to the content items, thumbnail information items and content information items corresponding to the content items may be stored in the memory 103.

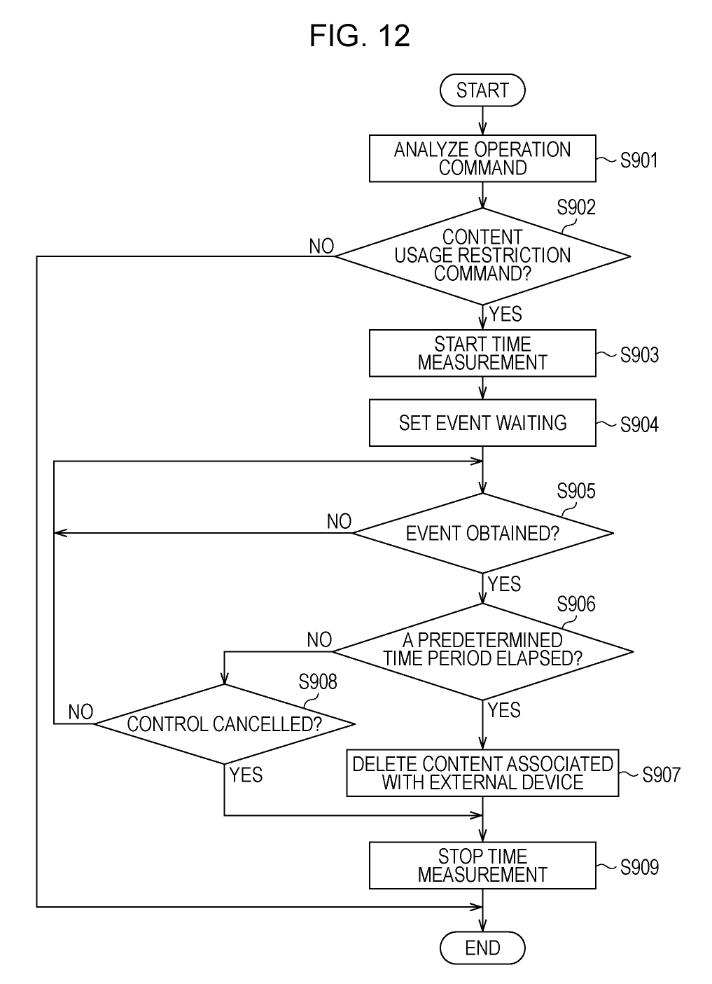

FIG. 12 is a flowchart illustrating an example of an operation of deleting a content item obtained from an external device when a predetermined time period is elapsed after an operation command is transmitted from the external device which is connected to the content management apparatus 100.

When the operation detector 205 detects operation information (an operation command) transmitted from the external device, the device operation controller 203 analyzes the operation command in step S901.

In step S902, the device operation controller 203 determines whether the operation command represents restriction of use of a content item in accordance with a result of the analysis performed on the operation command. When the determination is affirmative in step S902, the process proceeds to step S903. On the other hand, when the determination is negative, the processing of FIG. 12 is terminated.

In step S903, the time management unit 207 starts measurement of a period of elapsed time (duration time of an operation).

In step S904, the time management unit 207 is set so as to wait until a certain-time-period-elapsed event which is generated when a predetermined time period has passed or a restriction-cancellation event generated when an operation command for cancelling restriction of use of a content item is detected is received.

In step S905, the time management unit 207 determines whether an event is received. When the determination is affirmative in step S905, the process proceeds to step S906, whereas when the determination is negative in step S905, the process returns to step S905 and the operation in step S905 is performed again.

In step S906, the time management unit 207 determines whether the received event is the certain-time-period-elapsed event. When the determination is affirmative in step S906, the process proceeds to step S907. On the other hand, when the determination is negative in step S906, the process proceeds to step S908.

In step S907, the device operation controller 203 performs a control operation in which a content item in which use thereof is restricted in accordance with the operation command is deleted from the memory 103. The device operation controller 203 may determine whether the content item is also stored in another device, and when the determination is affirmative, the content item may be deleted from the memory 103. Furthermore, instead of the control operation in which the content item is deleted, the device operation controller 203 may perform a control operation in which the content item is compressed and the compressed content item is stored in a predetermined area in the memory 103. In a case where this configuration is employed, a user authentication, for example, may be performed and the compressed content item may be decompressed only in response to an operation of an authorized user.

In step S908, the time management unit 207 (or the device operation controller 203) determines whether the received event is the restriction-cancellation event. When the determination is affirmative in step S908, the process proceeds to step S909. On the other hand, when the determination is negative in step S908, the process returns to step S905. In step S909, the time management unit 207 stops the measurement of the period of elapsed time started in step S903 and the processing illustrated in FIG. 12 ends.

The time management unit 207 manages periods of elapsed time after operation commands are issued from a plurality of external devices, and when at least one of the managed periods of elapsed time becomes larger than a predetermined period of time, content items associated with the corresponding one of the external devices are deleted. Here, the predetermined period of time may be defined for each external device, or may be set by the user.

As described above, according to this exemplary embodiment, content items which are unnecessarily scattered are automatically deleted while the user is not aware of the deletion, and accordingly, convenience is improved.

A storage medium including program code (software) capable of realizing the functions of the foregoing exemplary embodiments may be supplied to a system or an apparatus. Then, a central processing unit (a CPU or an MPU) included in the system or the apparatus may read and execute the program code stored in the storage medium. In this case, the program code itself which is read from the storage medium realizes the functions of the foregoing exemplary embodiments.

Furthermore, by executing the program code read using the central processing unit included in the system or the apparatus, an operating system (OS), for example, operating in the system or the apparatus may perform part of or entire processing in accordance with an instruction corresponding to the program code.

Furthermore, the program code read from the storage medium can be written in a function expansion card inserted into the system or the apparatus or written in a memory included in a connected function expansion unit. The CPU, for example, included in the function expansion card or the function expansion unit performs part of or entire processing in accordance with an instruction corresponding to the program code, and the functions of the foregoing exemplary embodiments are realized by the processing.

When the present invention is applied to the storage medium, the storage medium includes program code corresponding to the flowcharts described above.

As described above, according to the foregoing exemplary embodiments, when an operation to be performed on a certain content item is to be restricted, and when the certain content item has already been moved from a device which obtained the certain content item, the operation to be performed on the certain content item can be easily restricted by connecting the device and issuing an instruction from the device.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-317335 filed Dec. 7, 2007, which is hereby incorporated by reference herein in its entirety.

What is claimed is:

1. An information processing apparatus, comprising:
a detector configured to detect connection of an external device;
a determination unit configured to determine whether content associated with the external device is included in content data; and
an external device operation controller configured to set the content associated with the external device to be content to be operated by the external device when the detector detects connection of the external device and the determination unit determines that the content associated with the external device is included in the content data.

2. The information processing apparatus according to claim 1, further comprising:
an operation controller configured to control an operation performed on the content using an operation unit,
wherein the operation controller prioritizes an operation performed on the content using the external device over the operation performed using the operation unit when the detector detects the connection of the external device and the determination unit determines that the content associated with the external device is included in the content data.

3. The information processing apparatus according to claim 2, further comprising:
a display controller configured to control display of content in a display device,
wherein the display controller controls the display of content so that the operation performed on the content using the operation unit is not accepted when the detector detects the connection of the external device and the determination unit determines that the content associated with the external device is included in the content data.

4. The information processing apparatus according to claim 1,
wherein the external device operation controller operates the content associated with the external device in accordance with a change of a connection state of the external device when the detector detects the connection of the external device and the determination unit determines that the content associated with the external device is included in the content data.

5. The information processing apparatus according to claim 1,
wherein the external device operation controller operates the content associated with the external device in accordance with a change of a power supply state of the external device when the detector detects the connection of the external device and the determination unit determines that the content associated with the external device is included in the content data.

6. The information processing apparatus according to claim 1,
wherein the external device operation controller operates the content associated with the external device in accordance with a change of an inclination state of the external device when the detector detects the connection of the external device and the determination unit determines that the content associated with the external device is included in the content data.

7. The information processing apparatus according to claim 1, further comprising:
a time management unit configured to manage a time period,
wherein the time management unit deletes the content associated with the external device from a content storage device which stores the content when it is determined that a time period in which the external device performs an operation on the content associated with the external device is longer than a predetermined time period.

8. An information processing method for an information processing apparatus, the information processing method comprising:
detecting connection of an external device;
determining whether content associated with the external device is included in content data; and
setting the content associated with the external device to be content to be operated by the external device when the connection of the external device is detected and it is determined that the content associated with the external device is included in the content data.

9. The information processing method according to claim 8, further comprising:
controlling an operation performed on the content using an operation unit,
wherein an operation performed on the content using the external device is prioritized over the operation performed using the operation unit when red to set the content associated with the external device to be content to be operated by the external device when the connection of the external device is detected and it is determined that the content associated with the external device is included in the content data.

10. The information processing method according to claim 9, further comprising:
controlling display of content in a display device,
wherein the display of content is controlled so that the operation performed on the content using the operation unit is not accepted when the connection of the external device is detected and it is determined that the content associated with the external device is included in the content data.

11. The information processing method according to claim 8,
wherein the content associated with the external device is operated in accordance with a change of a connection state of the external device when the connection of the external device is detected and it is determined that the content associated with the external device is included in the content data.

12. The information processing method according to claim 8,
wherein the content associated with the external device is operated in accordance with a change of a power supply state of the external device when the connection of the external device is detected and it is determined that the content associated with the external device is included in the content data.

13. The information processing method according to claim 8,
wherein the content associated with the external device is operated in accordance with a change of an inclination state of the external device when the connection of the external device is detected and it is determined that the content associated with the external device is included in the content data.

14. The information processing method according to claim 8, further comprising:
managing a time period,
wherein the content associated with the external device is deleted from a content storage device which stores the content when it is determined that a time period in which the external device performs an operation on the content associated with the external device is longer than a predetermined time period.

15. A computer-readable medium having stored thereon a program which causes a computer to perform:
detecting connection of an external device;
determining whether content associated with the external device is included in content data; and
setting the content associated with the external device to be content to be operated by the external device when the connection of the external device is detected and it is determined that the content associated with the external device is included in the content data.
